(19) United States
(12) Patent Application Publication
(10) Pub. No.: US 2024/0330847 A1
(43) Pub. Date: Oct. 3, 2024

(54) COMPUTER ANALYSIS OF PERISHABLE ITEM DATA TO GENERATE COMPUTER GENERATED PURCHASE OPTIONS

(71) Applicant: International Business Machines Corporation, Armonk, NY (US)

(72) Inventors: STEVE MCDUFF, UNIONVILLE (CA); BEN Z. AKSELROD, GIVAT SHMUEL (IL); ANTHONY DI LORETO, MARKHAM (CA); KYLE D. ROBESON, NORTH YORK (CA)

(21) Appl. No.: 18/127,380

(22) Filed: Mar. 28, 2023

(51) Int. Cl. G06Q 10/087; G06Q 30/0601

(52) U.S. Cl. CPC G06Q 10/087; G06Q 30/0633

(57) ABSTRACT

Computer analysis of perishable item data to generate purchase options based on the perishable items expiration data and date of use. Analysis includes receiving a date of use of perishable item and determining the inventory availability of the perishable item. Analysis further includes generating an expiration time window for the perishable item based on the expiration data for the perishable item using a knowledge database for the perishable item. The expiration data can include a categorization of the perishable item and an expected shelf life. The generated data matrix of purchase options over a period of time are based on the expiration time window, the inventory availability, and the date of use of the perishable item received from a device. Further, analysis includes communicating the data matrix to the device used by the user.

### BACKGROUND

The present invention relates generally to the field of computer analysis of data for perishable items, and use of artificial intelligence to generate purchase options for a user using an ordering or purchasing software application.

Perishable items and foods have a freshness or shelf-life timeline which varies by the type of item or food. For example, produce has a lower shelf-life timeline than most household cleaners since produce expires quicker than most household cleaners. Furthermore, some produce such as bananas and avocados, are ripen after they are picked and are sometimes purchased before they are fully ripe and ready to be consumed. Meaning, if a consumer wants to purchase an avocado for consumption in 3 days they need to purchase an avocado which will be ripe to eat in 3 days.

Frequently users place orders or browse inventory on e-commerce websites or applications. A user interacts with a graphical user interface to select the type of goods or items and is able to place an order for in store pick up or delivery.

### SUMMARY

According to one embodiment of the present invention, a computer-implemented method for generating a data matrix for expiration of a perishable item and a date of use for the perishable item is disclosed. The computer-implemented method includes receiving, at a computer, a date of use of a perishable item from a device used by a user. The computer-implemented method further includes determining, by the computer, inventory availability of the perishable item. The computer-implemented method further includes generating, by the computer, an expiration time window for the perishable item based on expiration data for the perishable item using a knowledge database for the perishable item, the expiration data including a categorization of the perishable item and an expected shelf life. The computer-implemented method further includes generating, by the computer, a data matrix of purchase options over a period of time, based on the expiration time window, and the inventory availability, and the date of use of the perishable item. The computer-implemented method further includes communicating, by the computer, the data matrix to the device used by the user.

According to another embodiment of the present invention, a computer program product for generating a data matrix for expiration of a perishable item and a date of use for the perishable item is disclosed. The computer program product includes one or more computer readable storage media and program instructions stored on the one or more computer readable storage media. The program instructions include instructions to receive a date of use of a perishable item from a device used by a user. The program instructions further include instructions to determine inventory availability of the perishable item. The program instructions further include instructions to generate an expiration time window for the perishable item based on expiration data for the perishable item using a knowledge database for the perishable item, the expiration data including a categorization of the perishable item and an expected shelf life. The program instructions further include instructions to generate a data matrix of purchase options over a period of time, based on the expiration time window, and the inventory availability, and the date of use of the perishable item. The program instructions further include instructions to communicate the data matrix to the device used by the user.

According to another embodiment of the present invention, a computer system for generating a data matrix for expiration of a perishable item and a date of use for the perishable item is disclosed. The computer system includes one or more computer processors, one or more computer readable storage media, and computer program instructions, the computer program instructions being stored on the one or more computer readable storage media for execution by the one or more computer processors. The program instructions include instructions to receive a date of use of a perishable item from a device used by a user. The program instructions further include instructions to determine inventory availability of the perishable item. The program instructions further include instructions to generate an expiration time window for the perishable item based on expiration data for the perishable item using a knowledge database for the perishable item, the expiration data including a categorization of the perishable item and an expected shelf life. The program instructions further include instructions to generate a data matrix of purchase options over a period of time, based on the expiration time window, and the inventory availability, and the date of use of the perishable item. The program instructions further include instructions to communicate the data matrix to the device used by the user.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of computing environment, suitable for the execution of at least some of the computer code involved in performing the inventive methods, in accordance with at least one embodiment of the present invention.

FIG. 2 is a flow chart diagram depicting operational for a confidential communication system, in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Embodiments of the present invention recognize consumers oftentimes have an intended day of use for a product. An intended date of use can be the date the consumer intends to use or consume the product. Meaning, during the intended date of use day or window, the product needs to be fresh, ripe, or able for consumption or use. Most e-commerce platforms do not give the user the ability to specify the level of ripeness or shelf-life remaining of the item being ordered. Embodiments of the present invention recognize the need for a consumer to be able to add parameters to their purchases to indicate either a required freshness time window, ripeness level, or an intended date of consumption. Embodiments of the present invention recognize the need for users to be able to purchase items online which will be ripe or ready to be used within the user's date of intended use. Embodiments of the present invention allow a user to indicate their intended date of use and generate adjustable ripeness options for purchase.

Embodiments of the present invention different products have different freshness or ripeness timelines. For example, avocados have a shorter ripeness timeline than a can of beans. Embodiments of the present invention determine the shelf life or ripeness timeline of a particular food or product. For example, if the user is on a webpage buying strawberries, embodiments of the present invention determine the life span of a strawberry and further determine strawberries are ripe 5 to 7 days after picking. Embodiments of the present invention further recognize the shelf life or ripeness timeline of a product can vary based on the season, time of year, weather, or state of the product. For example, in the earlier season a produce item may have a longer lifespan than in the later season. In another example, a food or products life span may be dependent on if the food or product was fresh, canned, frozen, defrosted, or thawed. Embodiments of the present invention presents and displays multiple purchase options for a particular item based on the users intended date of use and each purchase option states a ripeness window or date and a respective price. For example, a graphical user interface displays three options for purchasing watermelon: (i) ripe today, (ii) ripe tomorrow, (iii) ripe in three days.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

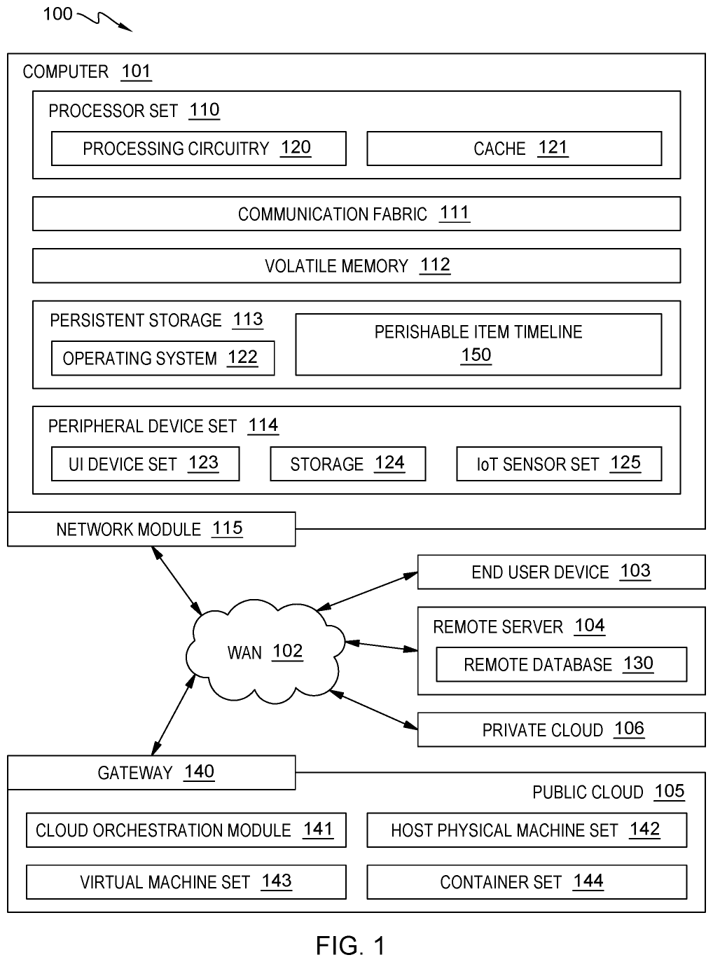

The present invention will now be described in detail with reference to the Figures. FIG. 1 is a functional block diagram of computing environment, generally designated 100, suitable for the execution of at least some of the computer code involved in performing the inventive methods, such as new perishable item timeline system code 150, in accordance with at least one embodiment of the present invention. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In an embodiment, perishable item timeline system may be configured to access various data sources, such as databases that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, confidential communication system enables the authorized and secure processing of personal data. In an embodiment, confidential communication system provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, confidential communication system provides information regarding personal data and the nature (e.g., type, scope, purpose, duration, etc.) of the processing. In an embodiment, perishable item timeline system provides a user with copies of stored personal data. In an embodiment, speech perishable item timeline system allows for the correction or completion of incorrect or incomplete personal data. In an embodiment, confidential communication system allows for the immediate deletion of personal data. In an embodiment, perishable item timeline system includes a database, such as remote database 130, which includes the ripeness timelines of produce, items, or other products.

In an embodiment, perishable item timeline system receives user input including a date of use of a perishable item. In an embodiment, the date of use of a perishable item can include the required freshness time window, ripeness level, or an intended date of consumption. For example, a user input includes information for required freshness time window for a loaf of bread is from today to five days away. Meaning, the user wants to purchase a loaf of bread that is ready to eat of use from today to in five days.

In an embodiment, perishable item timeline system determines the available inventory for a perishable item. For example, perishable item timeline system receives user input for the purchase of watermelon and further determines the availability inventory of watermelon or available watermelon for purchase. In an embodiment, perishable item timeline system determines the available inventory for a perishable item at a particular store or provider. In an embodiment, perishable item timeline system further determines when the available inventory was picked, delivered, frozen, baked, canned, or similar. For example, perishable item timeline system determines the availability inventory of watermelons contain a set of watermelons which were picked 3 days ago and another set of watermelons which were picked 1 day ago.

In an embodiment, perishable item timeline system further determines when the available inventory will expire or the expected shelf life. For example, perishable item timeline system determines from the available inventory of cans of corn that all cans of corn which were delivered to a store last week will expire or have a shelf life of six months.

In an embodiment, perishable item timeline system categorizes a perishable time. In an embodiment, perishable item timeline system categorizes a perishable time based on if the item is or was ever fresh, frozen, thawed, geographical region grown or received from, in season, not in season, sliced, skinned, peeled, or cut up, producer, farming techniques, or any other factors which would affect the shelf life of an item. For example, mangos which are peeled and sliced up will have a shorter shelf life than mangos that are not peeled and sliced up. In another example, apples from one geographical region may have a longer shelf life than apples grown in a different geographical region.

In an embodiment, perishable item timeline system generates an expiration time window for the perishable item. In an embodiment, the expiration time window is one or more days or times when the perishable item is expected to not be expired, is ripe for consumption, or is fresh for use. In some embodiments, the expiration time window begins at the time and day the product is baked, produced, picked, harvested, or canned. For example, muffins which are baked in an oven are ripe for consumption upon being baked. Further, the expiration time window on the muffins starts the day when the muffins are baked. In other embodiments, the expiration time window begins at a time later than when the product is baked, produced, harvested, picked, or canned. For example, some items such as avocados ripen after being harvested. Meaning, the expiration time window for avocados begins at a predetermined time after being harvested. For example, the expiration time window for avocados is 3 to 7 days after being harvested meaning the expiration time window begins at 3 days after being harvested and ends at 7 days after being harvested.

In an embodiment, determining an expiration time window further includes determining when the item is past ripeness or will be expired. For example, perishable item timeline system determines the ripeness timeline for mangos to include the mangos are ripe from two days after they are picked to two weeks after being picked. Here, perishable item timeline system further determines the mangos are past ripeness after two weeks and the expiration time window must end after two weeks of being picked.

In an embodiment, perishable item timeline system accesses a knowledge database which includes information on expiration timelines of items. For example, perishable item timeline system accesses a knowledge database including information that apples expire 10 to 14 days after they are picked when they are in season. In an embodiment, the knowledge database further includes information on perishability factors or categorizations which can affect the perishability or shelf life of items. For example, perishability factors can comprise when the item is in season, if was frozen, if the item was sliced, skinned, or cut up, if the item was thawed, and any other factors. For example, the knowledge database includes information that a container of meat was frozen then thawed, it will expire 2 days sooner than package of meat that was never frozen. In another example, the knowledge database includes information that pears are fresh for 10 to 14 days while in season but fresh 5 to 7 days when not in season.

In an embodiment, perishable item timeline system generates a data matrix of purchase options. In an embodiment, the data matrix of purchase options is based on purchase options over a period of time based on the expiration time window. For example, the data matrix of purchase options includes fresh produce, meaning produce which is ripe within the expiration time window. In an embodiment, the data matrix of purchase options is based on purchase options over a period of time based on the available inventory. In an embodiment, the data matrix of purchase options is based on products which are or will be in stock and products which are ripe based on their expiration time window. For example, perishable item timeline system determines a store has two patches of potatoes in stock, one with an expiration time window of today until 10 days and another with an expiration time window of today until 15 days. Here, perishable item timeline system determines a data matrix of two purchase options, potatoes with an expiration time window of 10 days and potatoes with an expiration time window of 15 days. In an embodiment, the data matrix of purchase options is based on the date of use of the perishable item. For example, perishable item timeline system receives user input the product has a remaining shelf life of 5 days. Here, perishable item timeline system generates a data matrix with three purchase options including a remaining shelf life of 5 days. Such as, purchase option for carrots (i): remaining shelf life 6 day; (ii): remaining shelf life 7 days; and (iii) remaining shelf life 8 days.

In an embodiment, perishable item timeline system determines a price associated with a ripeness date for an object. In an embodiment, the price is dependent on the expiration time window of the object. For example, produce which is going to expires in a few days, may be less expensive than produce which expires in a few weeks. In an example, if a grocery store has two shipments of premade salad mix where the first shipment includes 100 salad mixes which expire tomorrow and a second shipment which includes 30 salad mixes which expire in a week, the first shipment of salad mixes may be priced lower than the second shipment since the first shipment expires sooner.

In an embodiment, perishable item timeline system communicates the data matrix to the device used by the user. For example, user input includes information the user needs avocados for this upcoming Saturday. Here, perishable item timeline system generates a list of one or more purchase options for an item based on the date of use of a perishable item of this Saturday. For example, perishable item timeline system generates a matrix including three purchase options for avocados of: (i) ripe Thursday to Saturday $3/lbs; (ii) ripe Friday to Sunday $4/lbs; (iii) ripe Saturday to Monday $3.50/lbs. Here, all purchase options include Saturday, the intended date of consumption, as a day the avocados to be ripe

In an embodiment, perishable item timeline system communicates and displays the data matrix of purchase options. In an embodiment the one or more purchase options include an intended date of use or ripeness window and the respective price. For example, perishable item timeline system displays three purchase options for bananas, (i) ripe by today $1/lbs; (ii) ripe by tomorrow $2/lbs; and ripe in three days $1.50/lbs. In another example, perishable item timeline system displays three purchase options for strawberries, (i) ripe today July 1st to July 3rd $5/lbs; (ii) ripe July 4th to July 6th $6/lbs; and ripe July 6th to July 8th days $4/lbs. It is at the discretion of the user to select which exact purchase option is optimal for them. In an embodiment, perishable item timeline system receives user input selecting one of the purchase options. Such as in the previous strawberry example, perishable item timeline system receives user input selecting the third option of “ripe July 6th to July 8th days $4/lbs.”

In another example, perishable item timeline system receives user input that a user wants to buy a bouquet of sunflowers which are blooming today and will be in bloom at least the next three days. Here, perishable item timeline system determines the blooming timeline of sunflowers and further determines the inventory of the available sunflowers at a particular market. Perishable item timeline system determines sunflowers are in bloom from 1-10 days after being cut. Here, perishable item timeline system determines at the particular market a first batch of sunflowers were cut 3 days ago and a second batch of sunflowers were cut 6 days ago. Both batches of sunflowers are blooming today and will be blooming for the next 3 days. Perishable item timeline system determines a price for the first batch of sunflowers and the second batch of sunflowers. Perishable item timeline system displays two purchase options on a user device, one option for the first batch of sunflowers with the respective bloom time window and price and the second option for the second batch of sunflowers with the respective bloom time window and price. In an embodiment, perishable item timeline system receives user input to purchase the first batch of sunflowers.

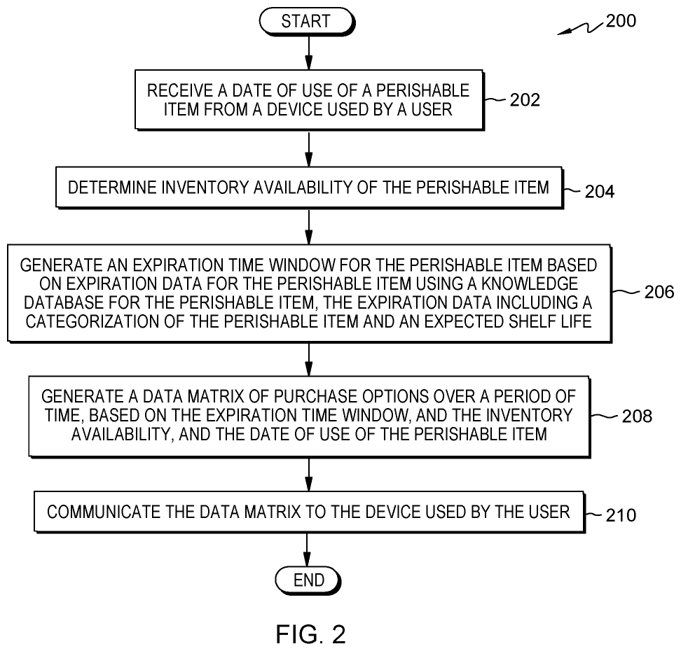

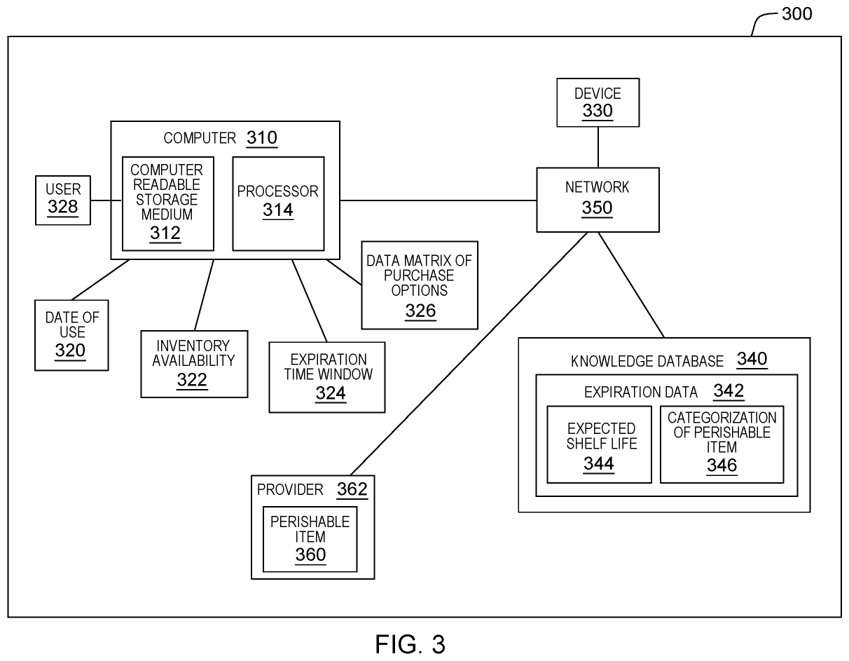

FIG. 2 is a flow chart diagram depicting operational steps for perishable commerce item timeline system, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

The perishable item timeline system receives, at a computer, a date of use of a perishable item from a device used by a user, as shown in block 202. In an embodiment, perishable item timeline system receives a user selection of a date of use of perishable item.

The perishable item timeline system determines, by the computer, inventory availability of the perishable item, as shown in block 204.

The perishable item timeline system generates, by the computer, an expiration time window for the perishable item based on expiration data for the perishable item using a knowledge database for the perishable item, the expiration data including a categorization of the perishable item and an expected shelf life, as shown in block 206. In an embodiment, the categorization of the perishable time based on if the perishable item is fresh, frozen, thawed, in season, not in season, sliced, skinned, peeled, or cut up. In an embodiment, the expiration time window for the perishable item begins at a time and a day the perishable item is baked, produced, picked, harvested, or canned. In an embodiment, the expiration time window for the perishable item begins at a time later than the perishable item is baked, produced, picked, harvested, or canned. In an embodiment, the expiration time window for the perishable item ends at a time the perishable item will be expired. In an embodiment, perishable item timeline system accesses a knowledge database which includes information on one or more expiration timelines of one or more perishable items.

The perishable item timeline system generates, by the computer, a data matrix of purchase options over a period of time, based on the expiration time window, and the inventory availability, and the date of use of the perishable item, as shown in block 208. In an embodiment, perishable item timeline system populates, by the computer, a purchase price for each respective purchase option, based, at least in part, on the expiration time window and the inventory availability.

The perishable item timeline system communicates, by the computer, the data matrix to the device used by the user, as shown in block 210. In an embodiment, perishable item timeline system communicates, by the computer, the purchase price for each respective purchase option.

FIG. 3 is a functional block diagram for perishable item timeline system, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

As depicted in FIG. 3, environment 300, includes network 350 communicably connected to computer 310, device 330, knowledge database 340, and provider 362. In an embodiment, provider 362 is communicably connected to computer 310. Computer 310, device 330, knowledge database 340, and provider 362 can be communicably connected by means of Wi-Fi, the internet, cables, or any other type of known means for communicably connecting.

As depicted, computer 310 includes computer readable storage medium 312 and processor 314. Connected to computer 310 is user 328, date of use 320, inventory availability 322, expiration time window 324, and data matrix of purchase options 326. In an embodiment, user 328 is connected to network 350 or provider 362. Provider 362 is connected to network 350 and includes perishable item 340. Knowledge database 340 is connected to network 350 and further includes expiration data 342 which further includes expected shelf life 344 and categorization of perishable item 346. In an embodiment, categorization of perishable item 346 includes information of the categorization of the perishable time based on if the perishable item is fresh, frozen, thawed, in season, not in season, sliced, skinned, peeled, or cut up.

In an embodiment, computer 320 receives date of use 320 from device 330. In an embodiment, inventory availability 322 is the inventory availability of perishable item 340. In an embodiment, expiration time window 324 is generated based, at least in part, on expiration data 342, categorization of perishable item 346, and expected shelf life 344. In an embodiment, data matrix of purchase options 326 is determined by date of use 320, inventory availability 322, and expiration time window 324. In an embodiment, data matrix of purchase options 326 includes a price for one or more purchase options.

What is claimed is:

1. A computer-implemented method for generating a data matrix for expiration of a perishable item and a date of use for the perishable item, the computer-implemented method comprising:
receiving, at a computer, a date of use of a perishable item from a device used by a user;
determining, by the computer, inventory availability of the perishable item;
generating, by the computer, an expiration time window for the perishable item based on expiration data for the perishable item using a knowledge database for the perishable item, the expiration data including a categorization of the perishable item and an expected shelf life;
generating, by the computer, a data matrix of purchase options over a period of time, based on the expiration time window, the inventory availability, and the date of use of the perishable item; and
communicating, by the computer, the data matrix to the device used by the user.

2. The computer-implemented method of claim 1, further comprising:
populating, by the computer, a purchase price for each respective purchase option, based, at least in part, on the expiration time window and the inventory availability; and
communicating, by the computer, the purchase price for each respective purchase option.

3. The computer-implemented method of claim 1, wherein the categorization of the perishable time based on if the perishable item is fresh, frozen, thawed, in season, not in season, sliced, skinned, peeled, or cut up.

4. The computer-implemented method of claim 1, wherein the expiration time window for the perishable item begins at a time and a day the perishable item is baked, produced, picked, harvested, or canned.

5. The computer-implemented method of claim 1, wherein the expiration time window for the perishable item begins at a time later than the perishable item is baked, produced, picked, harvested, or canned.

6. The computer-implemented method of claim 1, wherein the expiration time window for the perishable item ends at a time the perishable item will be expired.

7. The computer-implemented method of claim 1, further comprising:
accessing, by the computer, a knowledge database which includes information on one or more expiration timelines of one or more perishable items.

8. A computer program product for generating a data matrix for expiration of a perishable Item and a date of use for the perishable item, the computer program product comprising one or more computer readable storage media and program instructions stored on the one or more computer readable storage media, the program instructions including instructions to:
receive a date of use of a perishable item from a device used by a user;
determine inventory availability of the perishable item;
generate an expiration time window for the perishable item based on expiration data for the perishable item using a knowledge database for the perishable item, the expiration data including a categorization of the perishable item and an expected shelf life;
generate a data matrix of purchase options over a period of time, based on the expiration time window, the inventory availability, and the date of use of the perishable item; and
communicate the data matrix to the device used by the user.

9. The computer program product of claim 8, further comprising instructions to:
populate a purchase price for each respective purchase option, based, at least in part, on the expiration time window and the inventory availability; and
communicate the purchase price for each respective purchase option.

10. The computer program product of claim 8, wherein the categorization of the perishable time based on if the perishable item is fresh, frozen, thawed, in season, not in season, sliced, skinned, peeled, or cut up.

11. The computer program product of claim 8, wherein the expiration time window for the perishable item begins at a time and a day the perishable item is baked, produced, picked, harvested, or canned.

12. The computer program product of claim 8, wherein the expiration time window for the perishable item begins at a time later than the perishable item is baked, produced, picked, harvested, or canned.

13. The computer program product of claim 8, wherein the expiration time window for the perishable item ends at a time the perishable item will be expired.

14. The computer program product of claim 8, further comprising instructions to:
access a knowledge database which includes information on one or more expiration timelines of one or more perishable items.

15. A computer system for generating a data matrix for expiration of a perishable Item and a date of use for the perishable item, comprising:
one or more computer processors;
one or more computer readable storage media;
computer program instructions;
the computer program instructions being stored on the one or more computer readable storage media for execution by the one or more computer processors; and
the computer program instructions including instructions to:
receive a date of use of a perishable item from a device used by a user;
determine inventory availability of the perishable item;
generate an expiration time window for the perishable item based on expiration data for the perishable item using a knowledge database for the perishable item, the expiration data including a categorization of the perishable item and an expected shelf life;
generate a data matrix of purchase options over a period of time, based on the expiration time window, the inventory availability, and the date of use of the perishable item; and
communicate the data matrix to the device used by the user.

16. The computer system of claim 15, further comprising instructions to:
populate a purchase price for each respective purchase option, based, at least in part, on the expiration time window and the inventory availability; and
communicate the purchase price for each respective purchase option.

17. The computer system of claim 15, wherein the categorization of the perishable time based on if the perishable item is fresh, frozen, thawed, in season, not in season, sliced, skinned, peeled, or cut up.

18. The computer system of claim 15, wherein the expiration time window for the perishable item begins at a time and a day the perishable item is baked, produced, picked, harvested, or canned.

19. The computer system of claim 15, wherein the expiration time window for the perishable item begins at a time later than the perishable item is baked, produced, picked, harvested, or canned.

20. The computer system of claim 15, wherein the expiration time window for the perishable item ends at a time the perishable item will be expired.
